(19) United States
(12) Patent Application Publication
(10) Pub. No.: US 2013/0190157 A1
(43) Pub. Date: Jul. 25, 2013

(54) FABRIC FASTENING METHOD AND DEVICE FOR CARRYING OUT THE SAID METHOD

(71) Applicant: Tamara Teimurazovna GOGIBERIDZE, Moscow (RU)

(72) Inventor: Tamara Teimurazovna GOGIBERIDZE, Moscow (RU)

(21) Appl. No.: 13/795,533

(22) Filed: Mar. 12, 2013

Related U.S. Application Data
(63) Continuation of application No. PCT/RU2011/000975, filed on Dec. 12, 2011.

(30) Foreign Application Priority Data
Jun. 14, 2011 (RU) 2011123968
Jun. 30, 2011 (RU) 2011126874

(51) Int. Cl. F16B 2/24

(52) U.S. Cl. CPC F16B 2/241
USPC 493/394; 24/545

(57) ABSTRACT

The cloth of different size and form is fixed on a surface, fastening elements are fixed in the body of the cloth preventing their movement along the cloth, the fastening elements are chosen considering the need for multiple folding and prompt fastening of fastening elements in the folded position. A fastening element is folded lengthwise along the rectangular edge of the surface at a 90° angle, then folded again at a 90° angle. In another embodiment a fastening element is folded crosswise along rounded edge of the surface, the edge of the fastening element, after going round the surface, should be adjacent the inner side of the surface. In another embodiment a fastening element is folded crosswise along figured edge of the surface repeating its form, the edge of the fastening element after folding along the edge of the surface, should be adjacent the inner side of the surface.

### RELATED APPLICATIONS

This application is a continuation of International Patent Application No. PCT/RU2011/000975, filed Dec. 12, 2011, which claims priority to Russian Patent Application No. 2011123968, filed Jun. 14, 2011, and Russian Patent Application No. 2011126874, filed Jun. 30, 2011, all of which are incorporated herein by reference in their entirety.

### FIELD OF THE INVENTION

The invention relates to the light industry and can be used in different spheres, namely: everyday life, medicine, social life, cooking, and sport.

### BACKGROUND OF THE INVENTION

There is a cloth fastening method called “Toilet tank cover set” (U.S. Pat. No. 3,166,112, priority Mar. 14, 1963, published Jan. 19, 1965.) In the claimed solution, the cloth is fixed to an object in the following way: cloth edges are fixed to each other using textile elastics, which have press studs on both sides, and the cloth has holes for the press studs.

Drawbacks of the solution are its limited function, the time spent on the press studs fastening a certain surface, and usage of additional material for fastening i.e. elastics.

“Towel for Hair Styling” (see U.S. Pat. No. 6,655,387, International Patent Classification (IPC) A45D 7/04, A45D 44/00, priority Apr. 10, 2001, published Dec. 2, 2003) is the closest solution to the claimed method in terms of its essential features and result.

This solution represents a rectangular towel. In the center of a longer side a cut is made from the edge to the center of the towel, the cut is parallel to the shorter sides. From the right and left edges from the beginning of the cut fastening elements (i.e. textile Velcro fastening elements) are attached. Then the finished towel is folded lengthways and fixed on a man's (object) neck. This solution was chosen as a prototype for the method described in this document.

In this patent one of the drawbacks of the previous alike invention is eliminated: cloth fastening (fixation) to an object is made more convenient.

However, the prototype has its own drawbacks, namely: limited function, complexity of production, and unaesthetic look.

There is a device for cloth fastening called “Attachable type beach towel for universal use” (see U.S. Pat. No. 5,441,789, IPC B32B 03/14, priority Jan. 21, 1994, published Aug. 15, 1995). In the claimed solution the rectangular cloth has four lengthened fastening elements, thoroughly fixed on the other side of the cloth. The fastening elements represent belts, on each shorter side two belts and two buttonholes (also thoroughly fixed on the cloth) are attached. The buttonholes for the belts fastening are made at the similar distance as the fastening belts from the longer side and at some distance from the shorter side.

The drawbacks of this solution are limited function, time spent on fastening elements fastening on the surface and the need for crossbeams, handles, and headrest to fix the loop made by the fastening belt.

The closest analog to the claimed solution with respect to the essential features and the results is “Towel easy to be wound fixed around the body” (see U.S. Pat. No. 5,756,177, IPC A41D 07/00, priority Sep. 23, 1996, published May 26, 1998).

This solution represents a rectangular towel, at some distance from one longer side of the towel a textile tape is attached along its full length, on the right and left sides fixing elements are attached: on one side buttonholes (four types) are made, and on the other side fastening elements (two types) are attached. This solution was chosen as a prototype for the device.

In this patent one of the drawbacks of the previous device is eliminated i.e. fastening (fixating) of the cloth on an object is made more convenient.

However the prototype has its own drawbacks, namely: limited function, complexity of production and time spent on fastening. Also, the device has a limitation for use by people, who has huge difference in close sizes.

The technical solution in accordance with the prototype for the device and method cannot ensure an increase in function of the claimed method, it is used only for a certain type of the object, needs much time for actions made before usage (fastening) and also many inputs in its production, the solution can not ensure usage of one and the same method for objects of different forms and sizes.

### SUMMARY OF THE INVENTION

The aim of the claimed technical solution is an increase in functions of the claimed method and device, a decrease in the time spent on actions made before its usage (putting on and fastening), a reduction of technological complexity, and also reduction of costs on production via using one and the same device by people who have different sizes of clothes and for objects of different sizes.

The technical result by the method of cloth fastening is that the cloth of different size and form is fixed on the surface, at that fastening elements are fixed in the body of the cloth preventing their free moving along the cloth, the fastening elements should be chosen taking into consideration the need for multiple folding and prompt fastening of fastening elements in the folded position. In accordance with one of solutions, a fastening element is folded crosswise along the rectangular edge of the surface at the 90° angle and then it is folded one more time at the angle of 90°. In another solution, a fastening element is folded crosswise along rounded edge of the surface (the fastening element goes round the surface), at that, the edge of the fastening element, after going round the surface, should be adjacent the inner side of the surface. In the next solution a fastening element is folded crosswise along figured edge of the surface repeating its form, at that, the edge of the fastening element after folding along the edge of the surface, should be adjacent the inner side of the surface. A solution, in which a fastening element is folded crosswise and spiral round the surface, is also possible.

The technical result for the device for cloth fastening, which includes at least one fastening element, is obtained thanks to the possibility of multiple folding of the fastening element and its fastening preventing free moving along the cloth, at the same time the fastening element made of light and soft metal is promptly fixed in the folded position. In one solution fastening elements are partially fixed on the cloth. Fastening elements can be of different form depending on the form of the cloth. Brass is used as material for fastening elements production. The fastening element is enclosed in a plastic casing. In other solution a fastening element is made of multi-cored copper wire in a plastic casing. Fastening elements are fixed to the cloth in different places. In one of the solutions fastening elements are fixed in the cloth turn-up of the finished product. In other solution fastening elements are fixed to the cloth via additional covers, for example, made of cloth.

### BRIEF DESCRIPTION OF THE DRAWINGS

The claimed solution is explained in drawings, where:

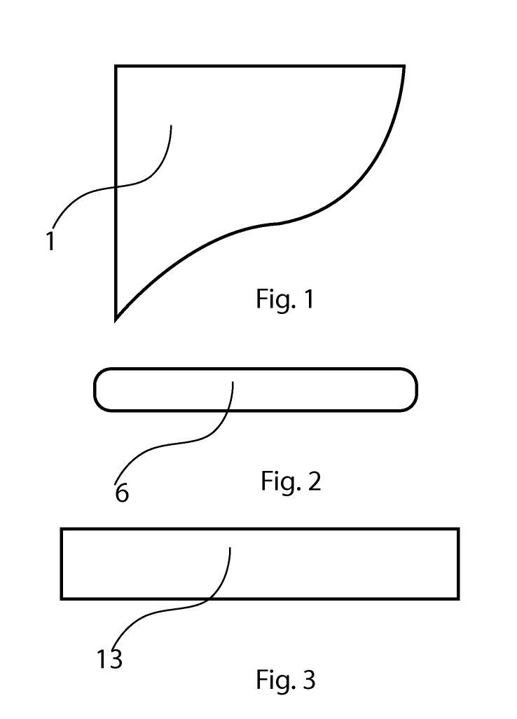

In FIG. 1 a fragment of cloth is shown.

In FIG. 2 a rectangular fastening element is shown.

In FIG. 3 a rectangular cover is shown.

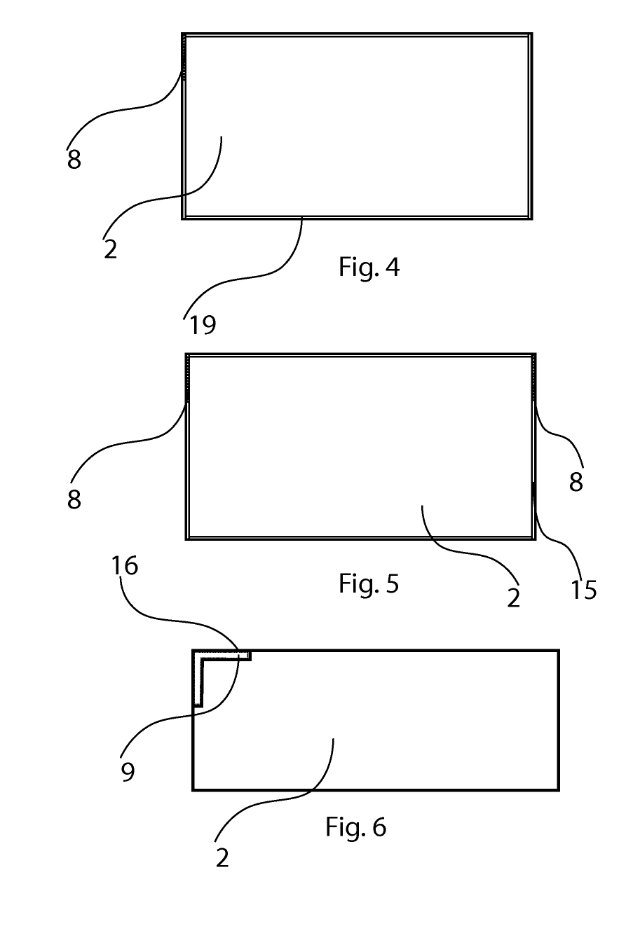

In FIG. 4 the back of a rectangular cloth with one fastening element along the shorter side is shown.

In FIG. 5 the back of a rectangular cloth with two fastening elements situated along shorter sides is shown.

In FIG. 6 the back of a rectangular cloth with one fixed Γ-type fastening element situated in the corner formed by the longer and the shorter sides is shown.

In FIG. 7 the back of a lengthened rectangular cloth with one fixed fastening element is shown; the fastening element is approximately two times longer than the cloth and is situated in the center parallel the longer sides of the cloth.

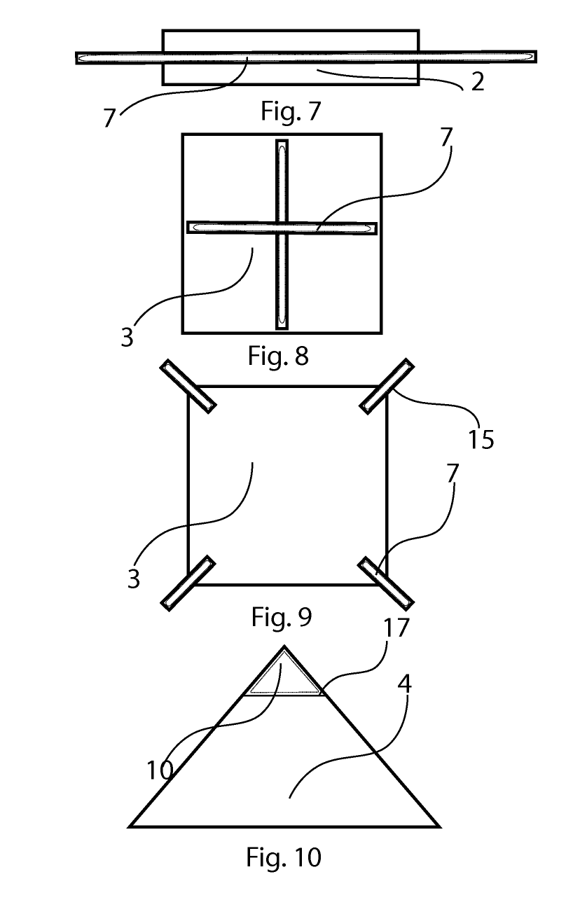

In FIG. 8 the back of a rectangular cloth with two rectangular fastening elements is shown; the fastening elements are fixed in the form of a crossbar in the center of the cloth.

In FIG. 9 the back of a rectangular cloth with four fastening elements partially fixed to the cloth is shown; the fastening elements are located in the corners of the cloth along the diagonals of the rectangular.

In FIG. 10 the back of a triangular cloth with one triangular fastening element in the corner is shown.

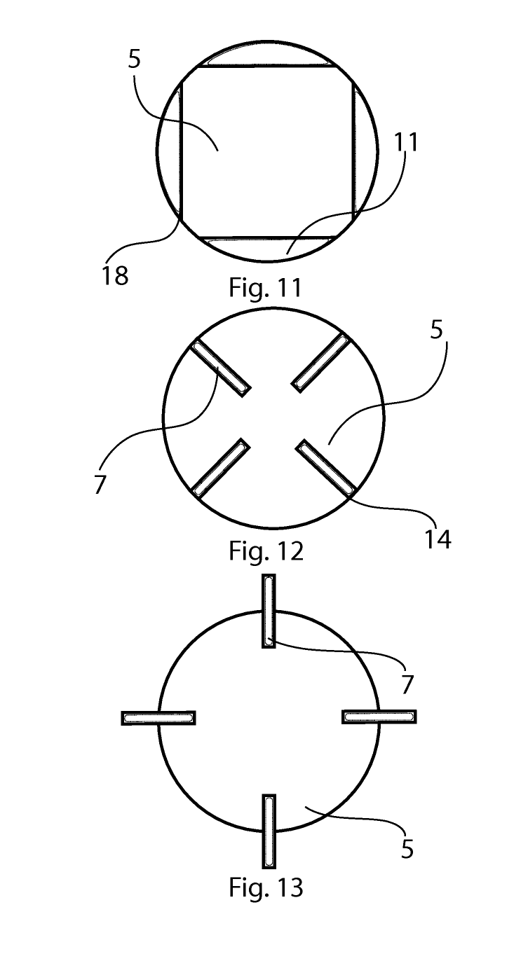

In FIG. 11 the back of a round cloth with four semicircular fastening elements is shown; the fastening elements are located at the edges of the cloth, symmetrically along the circle.

In FIG. 12 the back of a round cloth with four fixed rectangular fastening elements is shown; the fastening elements are located symmetrically along the radii.

In FIG. 13 the back of a round cloth with four fixed rectangular fastening elements is shown; the fastening elements are located symmetrically from the cloth edge to its center.

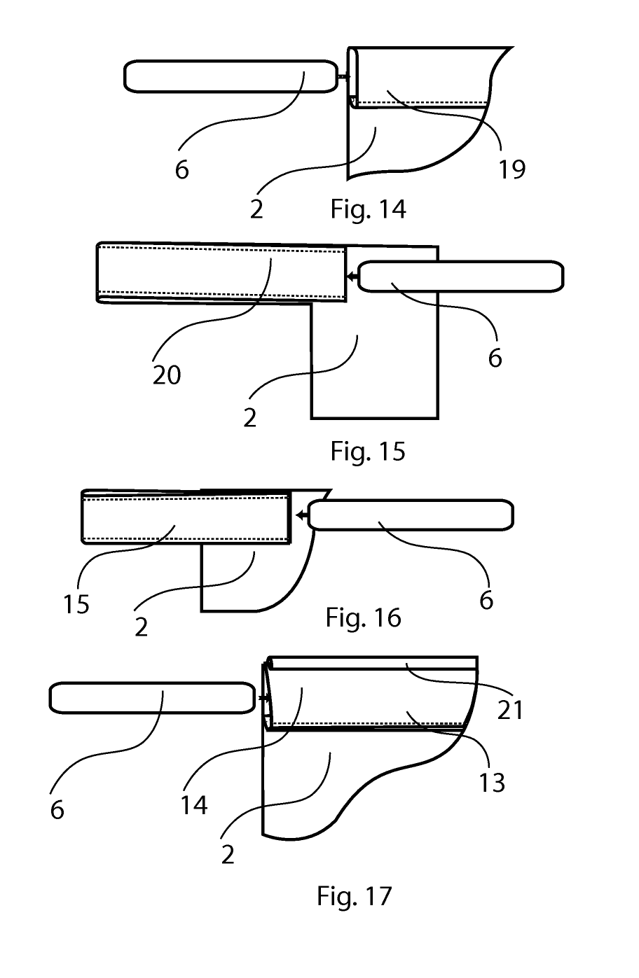

In FIG. 14 fastening of rectangular fastening element via its turning towards the edge of the cloth is shown.

In FIG. 15 fastening of rectangular fastening element via its turning towards the whole-cut edge of the cloth is shown.

In FIG. 16 partial fastening of fastening element via sewing on a two-layers cover is shown.

In FIG. 17 fixing of a rectangular fastening element is via sewing on a cover on the cloth edge is shown; the edge has additionally decorating piping.

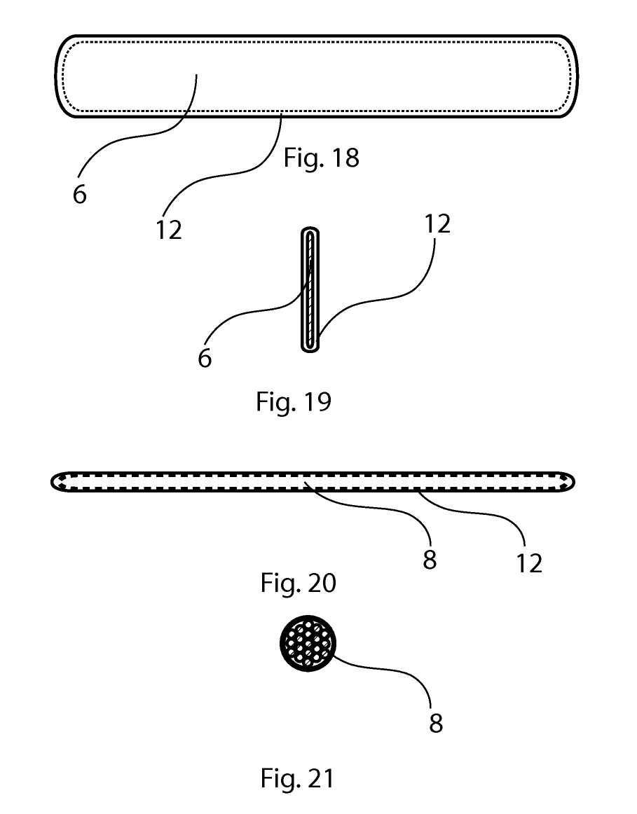

In FIG. 18 the location of a fastening element in the plastic casing is shown, front view.

In FIG. 19 cross section showing the location of a fastening element in the plastic casing is shown.

In FIG. 20 the location of a wire fastening element in the plastic casing is shown, front view.

In FIG. 21 cross section showing the location of a fastening element in the plastic casing is shown.

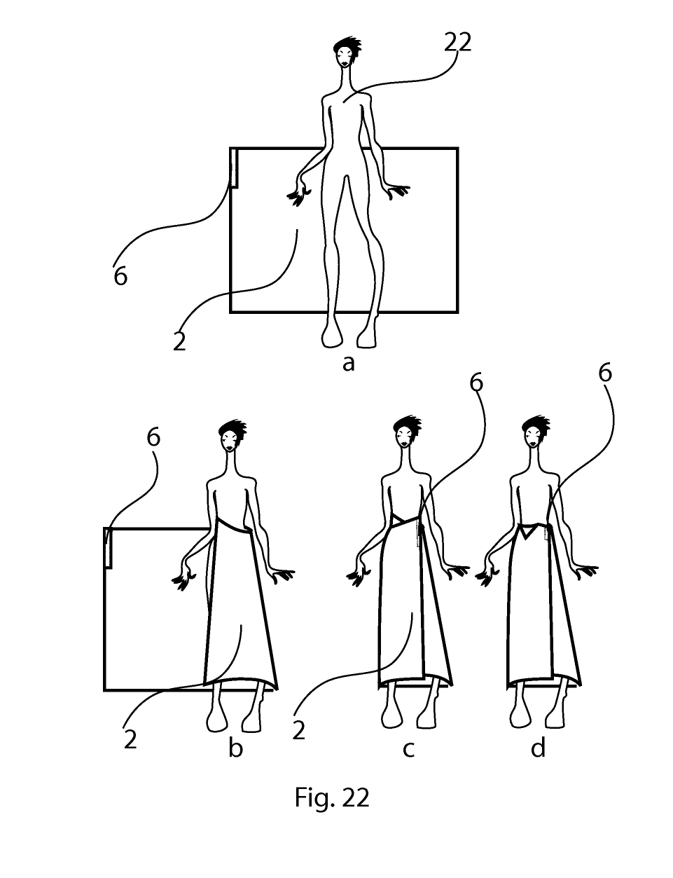

In FIGS. 22 a, b, c, d fixing of a rectangular cloth on the waist is shown, one rectangular fastening element is fixed in the rectangular cloth.

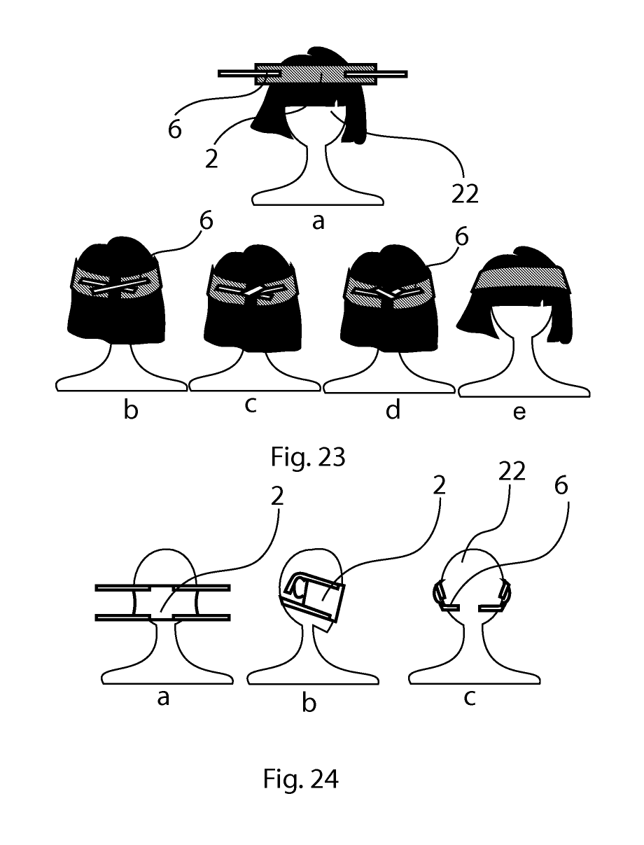

In FIGS. 23 a, b, c, d, e fixing of a rectangular cloth on the head is shown; the cloth has two partially fixed rectangular fastening elements located along the longer sides of the cloth, in the center of its shorter sides.

In FIGS. 24 a, b, c fixing of a rectangular cloth on the head is shown; the cloth has four partially fixed rectangular fastening elements located along the longer sides of the cloth, on the right and on the left side respectively.

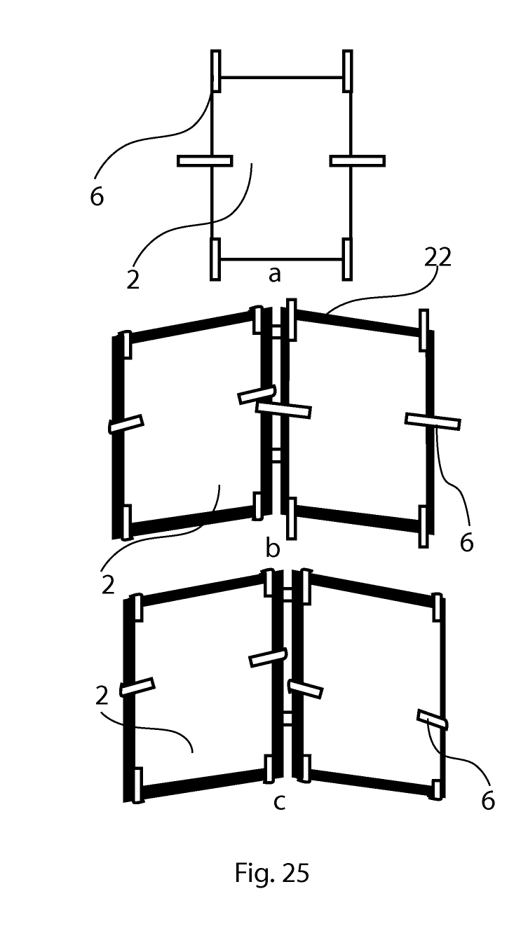

In FIGS. 25 a, b, c fixing of rectangular cloth on a frame of a screen is shown; the cloth has four partially fixed fastening elements along the right and left edge of the cloth, at the top and at the bottom respectively, and two partially fixed fastening elements located at the center of the right and left longer sides of the cloth.

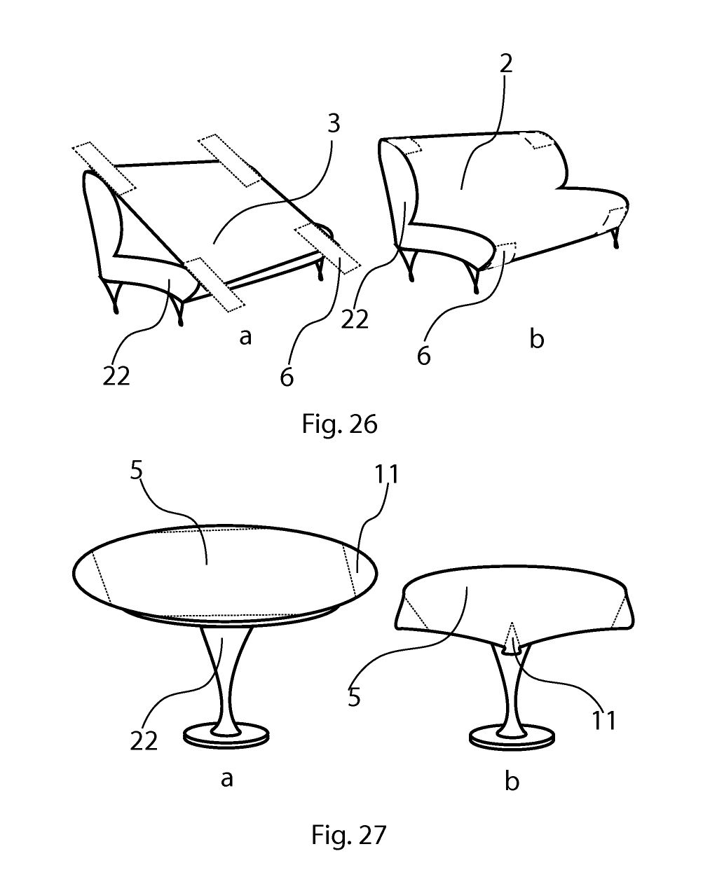

In FIGS. 26 a, b fixing of a square cloth on a sofa is shown; the cloth has two partially fixed rectangular fixing elements.

In FIGS. 27 a, b fixing of a round cloth in the form of a tablecloth on a table; the cloth has four semicircular fastening elements fixed in the cloth symmetrically along the cloth circle.

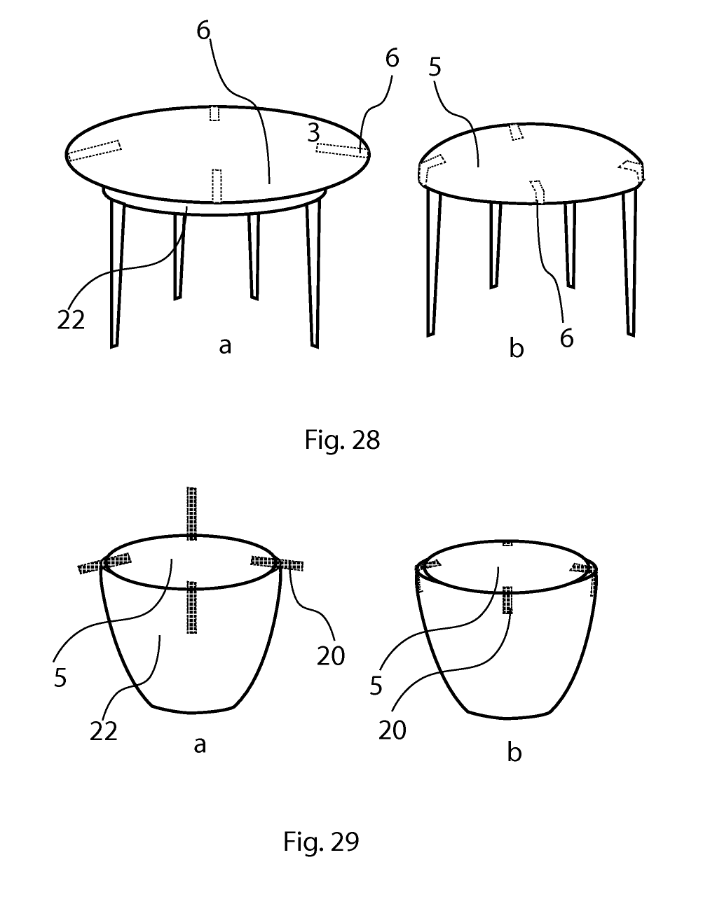

In FIGS. 28 a, b fixing of a round cloth in the form of a tablecloth on a table; the cloth has four rectangular fastening elements fixed in the cloth symmetrically along the cloth circle diameters.

In FIGS. 29 a, b fixing of a round cloth in the form of a lace pillow cover on a pillow is shown; the cloth has four partially fixed fastening elements located symmetrically along the circle diameters.

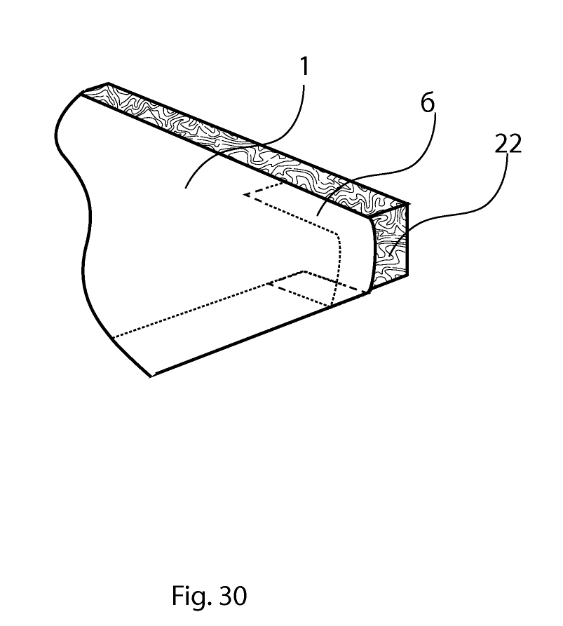

In FIG. 30 a fragment of a cloth with a fastening element on a rectangular surface is shown.

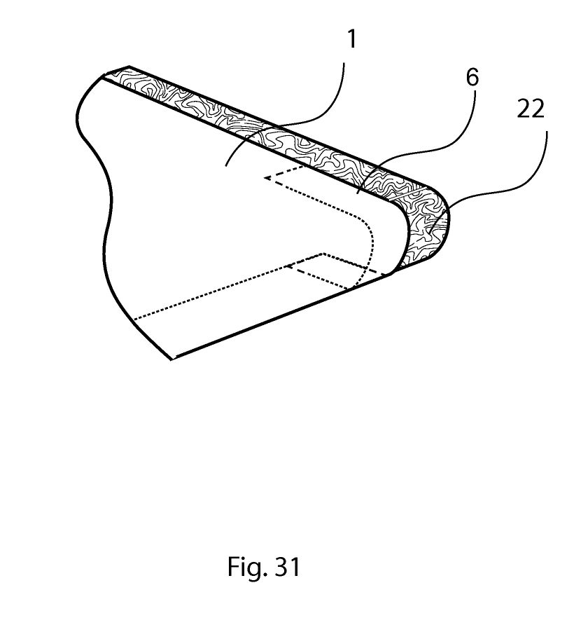

In FIG. 31 a fragment of a cloth with a fastening element on the rounded surface is shown.

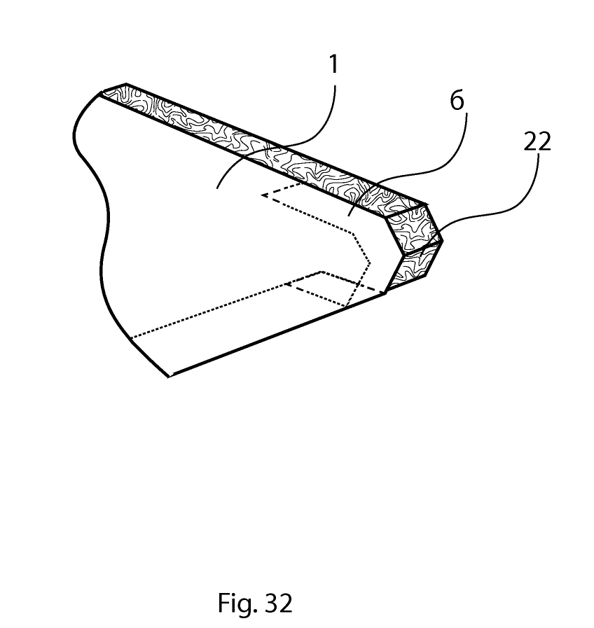

In FIG. 32 a fragment of a cloth with a fastening element on the figured surface is shown.

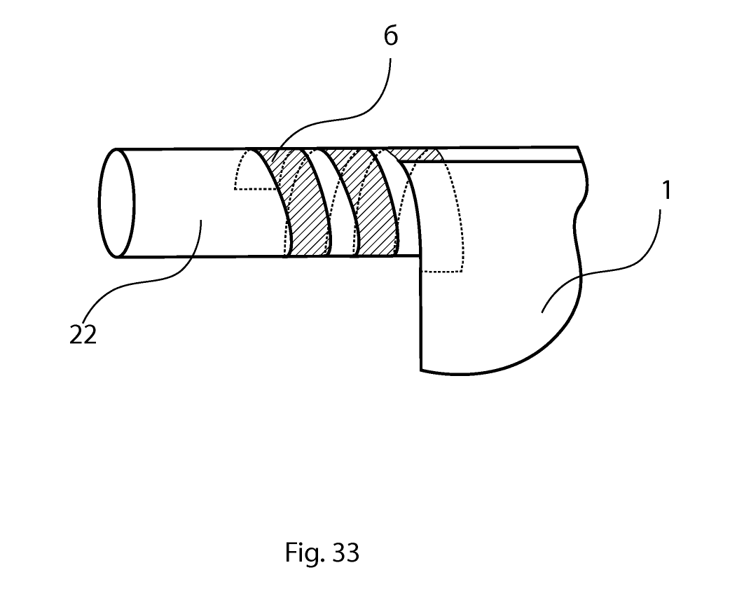

In FIG. 33 a fragment of a cloth with fastening element on the rounded surface is shown.

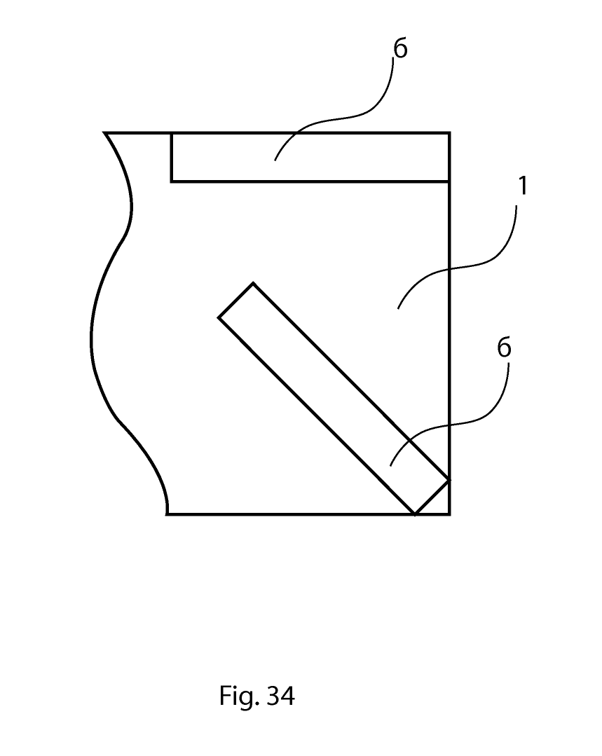

In FIG. 34 a fragment of a cloth with two rigidly fixed rectangular fastening elements is shown.

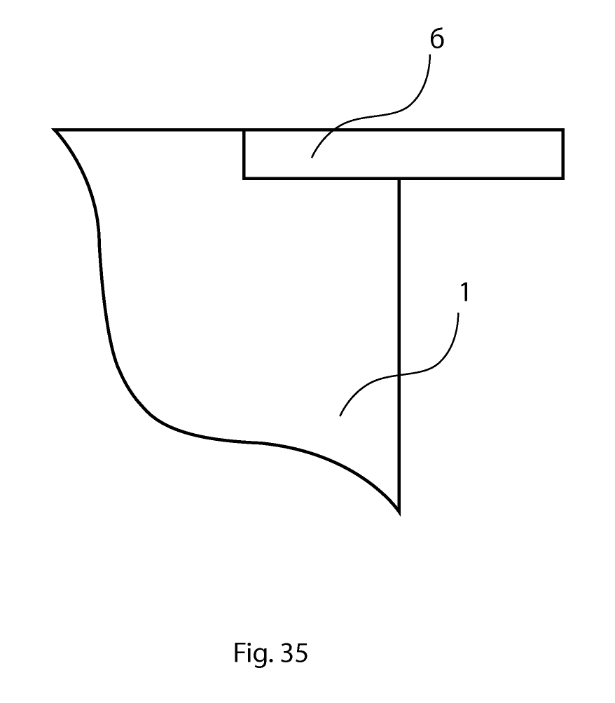

In FIG. 35 a fragment of a cloth with one partially fixed rectangular fastening element is shown.

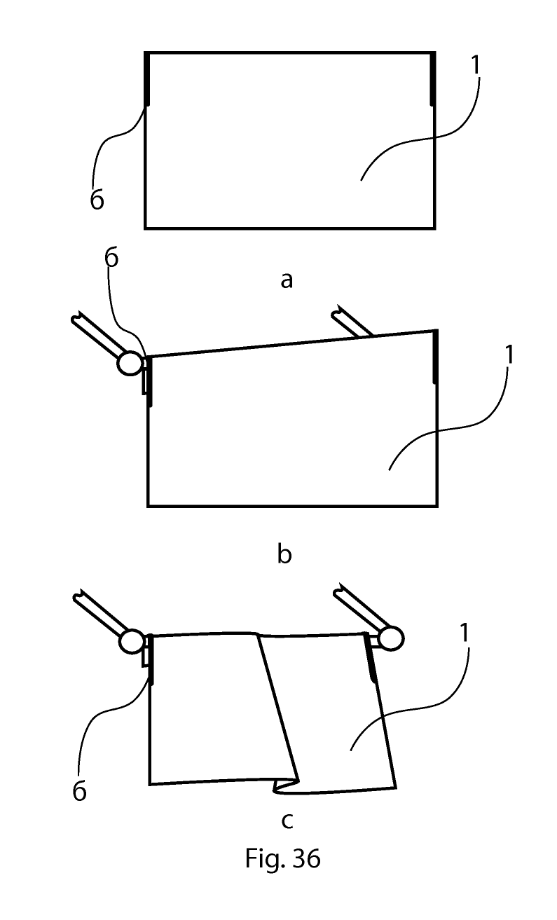

In FIGS. 36 a, b, c a method of fastening of a rectangular cloth on a towel rail is shown; the cloth has the form of a towel with two rigidly fixed in its body wire fastening elements located along shorter sides.

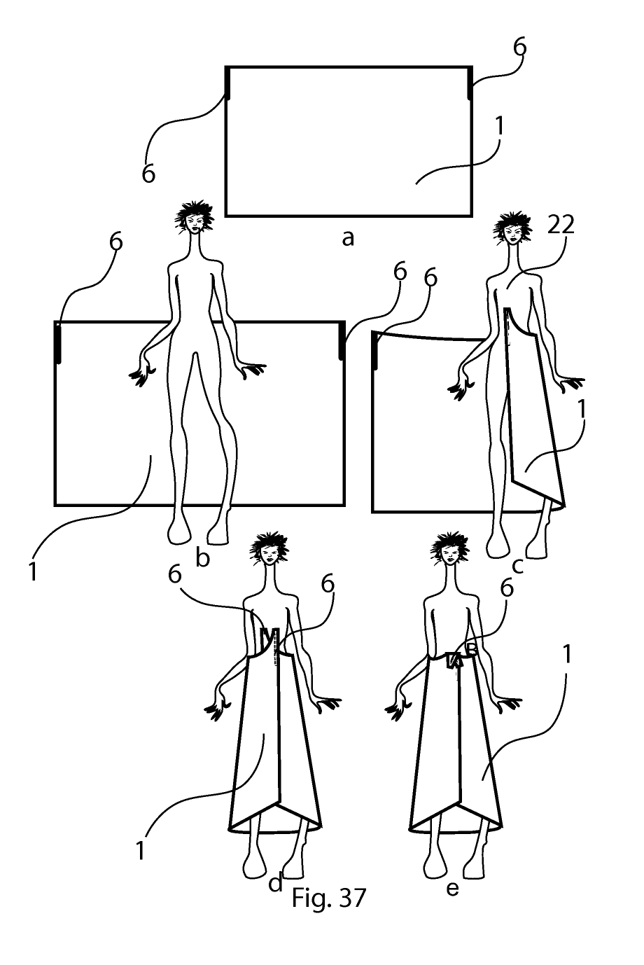

In FIGS. 37 a, b, c, d, e a method of a rectangular cloth fastening on the waist of a man; the cloth has the form of a towel with two rigidly fixed in its body wire fastening elements located along shorter sides.

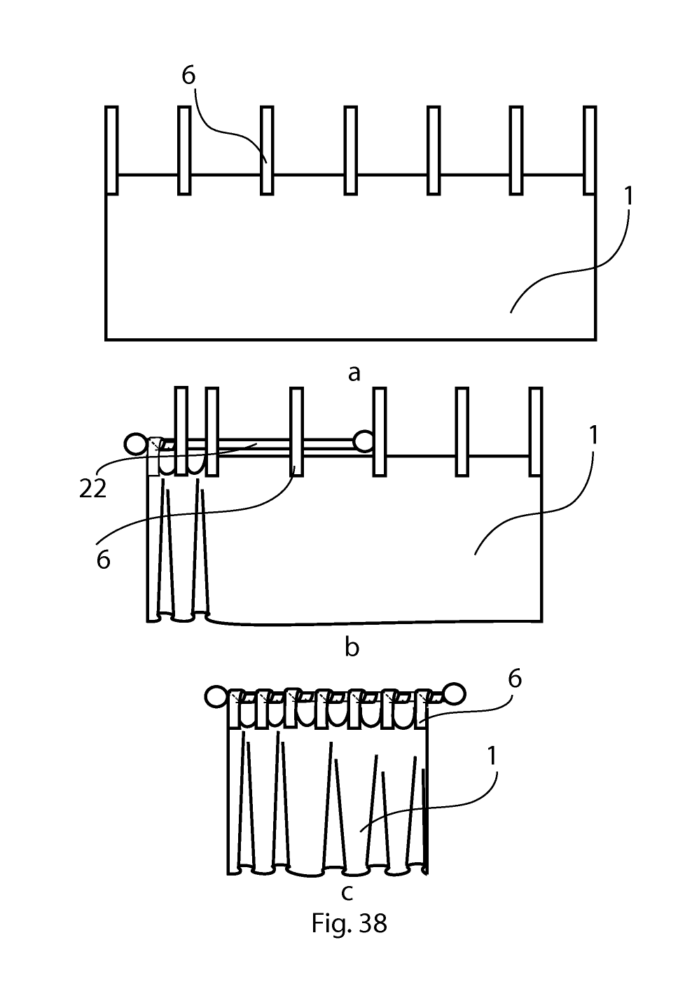

In FIGS. 38 a, b, c a method of fastening of a rectangular cloth on a ledge; the cloth has the form of a curtain with seven rectangular fastening elements partially fixed crosswise one of the longer sides; the fastening elements are located at even distances from each other.

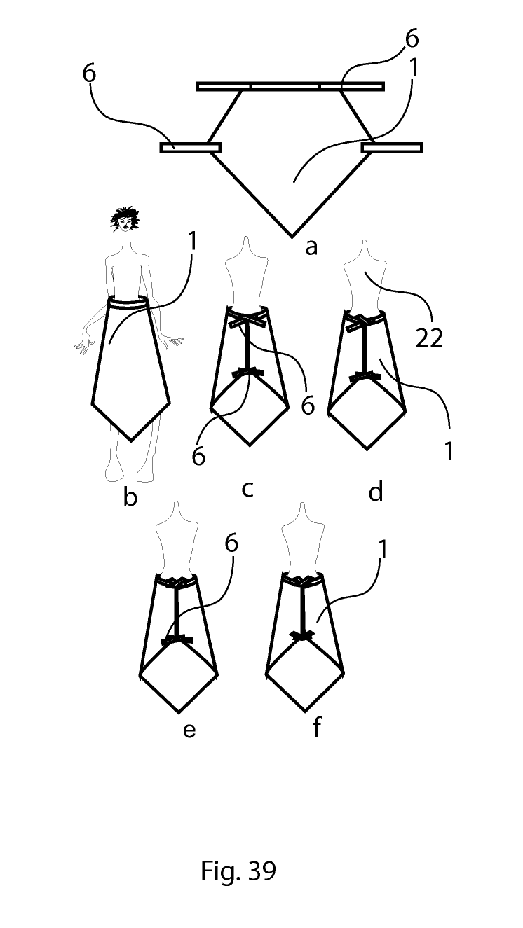

In FIGS. 39 a, b, c, d, e, f a method of fastening of a pentagonal cloth with two equal sides on a man's waist is shown; the cloth has the form of an apron with two rectangular fastening elements partially fixed along the upper edge of the unequal side and two rectangular fastening elements which are parallel to the first ones and are located in the opposite corners.

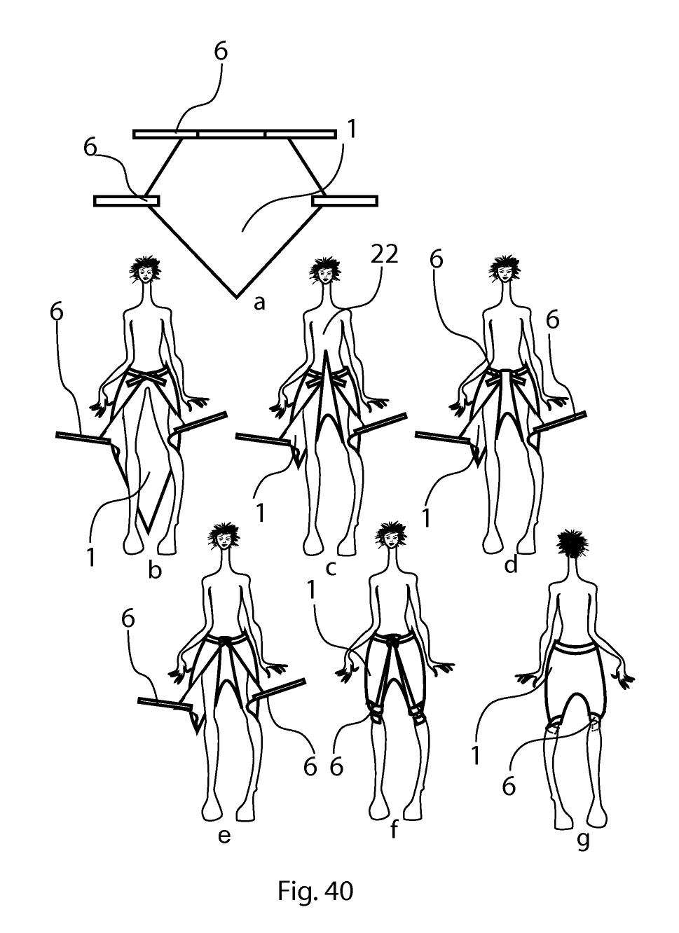

In FIGS. 40 a, b, c, d, e, f, g a method of fastening of a pentagonal cloth with two equal sides on a man's waist is shown; the cloth has the form of breeches with two rectangular fastening elements partially fixed along the upper edge of the unequal side and two rectangular fastening elements which are parallel to the first ones and are located in the opposite corners.

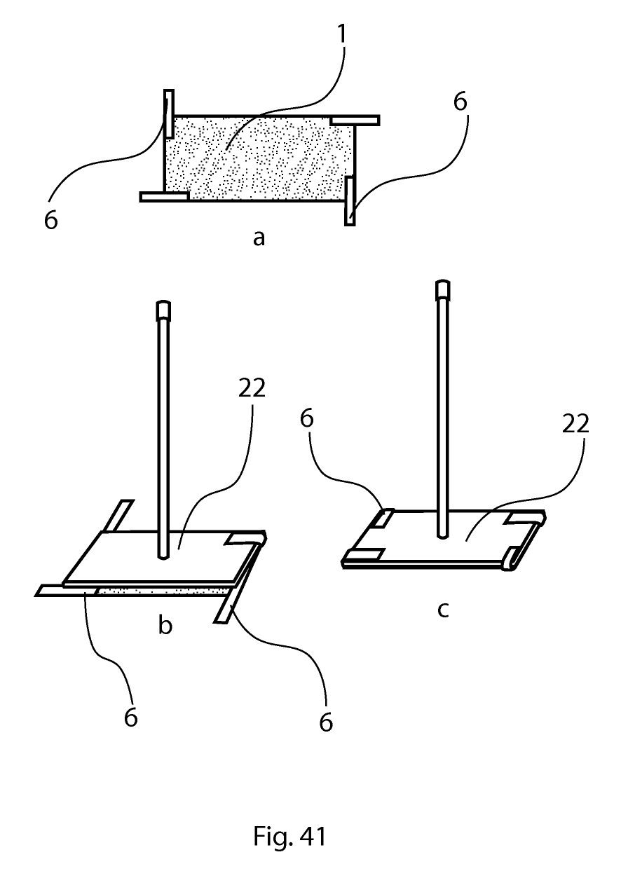

In FIGS. 41 a, b, c a method of fastening of a rectangular cloth having the form of a floor rag on a mop is shown; the cloth has two rectangular fastening elements partially fixed along longer sides and two rectangular fastening elements partially fixed crosswise the longer sides.

### DETAILED DESCRIPTION OF THE PREFERRED EMBODIMENTS

The claimed invention consists of cloth 1 (FIG. 1.), which can be made as rectangular cloth 2 (FIG. 4), square cloth 3 (FIG. 8), triangular cloth 4 (FIG. 10), round cloth 5 (FIG. 11); fastening element 6 (FIG. 2), made with the possibility of multiple folding and unfolding, which can be made as rectangular fastening element 7 (7, 8, 9), wire fastening element 8 (FIGS. 20, 21), Γ-type fastening element 9 (FIG. 6), triangular fastening element 10 (FIG. 10), semicircular fastening element 11 (FIG. 11). The fastening element 6 is made in a casing 12 (FIGS. 18, 19) for fastening elements. The solution made in accordance with the claimed invention can have cover 13 (FIGS. 1, 17) for fastening of fastening element 6 in it; the cover can be made as a one-side rectangular cover 14 (FIG. 17), two-layer rectangular cover 15 (FIG. 16), Γ-type cover 16 (FIG. 6), triangular cover 17 (FIG. 10), semicircular cover 18 (FIG. 11), the form depends on the cloth form. Fastening element 6 can be fixed in the turn-up of cloth edge 19 (FIGS. 14, 17) or in the turn-up of a separate cut in the body of cloth 20 (FIG. 15). Decorative piping 21 (FIG. 17) can be used. On object 22 (FIGS. 22-33, 36-41) a cloth 1 of any form can be fixed.

Such a construction as cloth 1 with fastening element 6 fixed in its body with the possibility of multiple folding and unfolding and prevention of free moving along cloth 1 (at that, fastening element is made of light and soft metal and is rigidly fixed in the folded position) helps to solve problems connected with cloth 1 fastening for its usage in different spheres, for example: fixing of bath and beach towels on the man's body, that is an inconvenience in baths, saunas, fitness industry, hotel and travel business, and everyday life. The solution represented in a prototype because of its method and construction needs huge time for production and can lead to an increase in cost of production, for example, of towels with system of fastening claimed in the prototype. The same problems appear when fixing furniture covers, lace pillow covers, bedspreads, tablecloths, face bandages, baby's bib etc. The solution claimed by this useful model can resolve the problems.

Fastening elements 6 are made in such a way that there is a possibility of multiple folding and unfolding. They are made as rectangular fastening elements 8, or as Γ-type fastening elements 9, or s triangular fastening elements 10, or as semicircular fastening elements 11, or as fastening elements 6 of any other form defined by the manufacturer.

Fastening elements 6 can have different size depending on function and purpose of the cloth 1, different quantity and can be located in different places on cloth 1 (FIG. 4-FIG. 20). Fastening elements 6 can be partially fixed in the main body of the cloth 1 (FIGS. 4-13) depending on the purpose of the fixing cloth 1.

The fastening elements 6 can have the form of rectangular plates that length are at least 5 times bigger than their width, and which thickness is at least 0.3 mm Fastening elements 6 are made of plates of light and soft metal (for example, copper M1-M or brass L63-M) with rounded edges, on their outer side metal plates have cover 12 for fastening elements in the form of, for example, thin formed two-side cover of soft plastic or rubber. Wire fastening elements 8 are made of multi-cored wire, at that they have plastic cover 12.

Cover 12 ensures protection of cloth 1 and surfaces (man's body and other objects) from mechanical damages.

Fastening elements 6 are fixed to cloth 1 using covers 13. The covers can be one-sided rectangular covers 14, or two-sided rectangular covers 15, or Γ-type covers 16, or triangular covers 17, or semicircular covers 18, or covers of any other form. Covers 13 form pockets, or such pockets are formed in the course of the cloth 1 hemming, the pockets are extended inwards for the width slightly exceeding the width of the fastening elements.

Covers 13 have the form of fastening elements 6 and their size is slightly exceed the size of the latter i.e. they have the form of an extruded rectangle, or they can be of a Γ-type circle or a triangle form. Depending on the cloth finishing decorative piping 21 can also be used. For aesthetic purposes, remains of cloth matching main cloth 1 or cuttings of denim can be used for such covers. For hemming a part of main cloth 1 is used.

Fastening elements 6 are fixed in the body of cloth 1 with prevention of their moving along cloth 1, for example, using stitches preventing fastening elements 6 moving along cloth 1.

Cloth 1 can be made as rectangular cloth 2 (FIGS. 4, 5, 6, 7). Cloth can be made as square cloth 3 (FIGS. 8, 9), as triangular cloth 4 (FIG. 10), as round cloth 5 (FIGS. 11, 12, 13).

So, the claimed device for cloth fastening includes, at least, one fastening element 6, which is made with a possibility of multiple folding and unfolding and is fixed on cloth 1 with prevention of its free moving along the cloth, and at that fastening element made of light and soft metal is rigidly fixed in the folded position. In one solution fastening elements 6 are partially fixed on the cloth (FIGS. 9, 13, 24, 25, 26, 29, 33, 35, 38, 39, 40, and 41). Fastening elements 6 can be of different form depending on the form of the cloth 1 (FIGS. 4-13). For example, brass is used as material for fastening elements production. At that the fastening element is enclosed in a plastic casing 12. In other solution fastening element 6 is made of multi-cored copper wire in a plastic casing (FIGS. 20, 21). Fastening elements 6 are fixed on cloth 1 in different places depending on purpose of the cloth. Fastening elements 6 can be fixed in the cloth itself using different methods of fastening. In one of the solutions fastening elements 6 are fixed in the cloth turn-up of the finished product (FIG. 14). In other solution fastening elements are fixed to the cloth via additional covers (FIG. 17), for example, made of cloth.

The claimed cloth fastening method is that cloth 1 of different size and form is fixed on the surface, at that fastening elements 6 are fixed in the body of cloth 1 preventing their free moving along the cloth, fastening elements 6 should be chosen taking into consideration the need for multiple folding and rigid fastening of fastening elements 6 in the folded position. In accordance with one of solutions, a fastening element is folded crosswise along the rectangular edge of the surface at the angle of 90°, and then it is folded one more time at the angle of 90 (FIG. 30). In another solution fastening element 6 is folded crosswise along rounded edge of the surface (the fastening element goes round the surface) (FIG. 31), at that, the edge of the fastening element 6, after going round the surface, should be adjacent the inner side of the surface. In the next solution the fastening element is folded crosswise along the figured edge of the surface (FIG. 32), repeating the form of the surface, at that the edge of fastening element 6 after folding along the figured edge of the surface is adjacent the inner side of the surface. A solution in which fastening element is folded crosswise and spiral round the surface is also possible.

For carrying out of the said method and device the following simple module is taken: cloth 1 that is made of, for example, textile, and can have different forms depending on its functions (rectangular cloth 2, square cloth 3, triangular cloth 4, round cloth 5 etc.), depending on functions of the cloth on its (one, two, three or four) edges covers 13 (for example, made of textile cloth) are sewn, the form of the covers should fit fastening elements 6, and their size should slightly exceed the size of fastening elements 6. In the pocket formed between cloth 1 and covers 13 fastening elements 6 are inserted, after that cloth 1 and cover 13 in that place are rigidly fixed relative to each other (for example, by a stitch), after that the product can be used.

### Best Variants of Implementation of the Method and Device being Claimed

When using the claimed method and device for cloth 1, which is, for example, bath or beach towel. In such a case rectangular cloth 2 with one (FIG. 4) or two fastening elements 6 (FIG. 5) is used; rectangular cloth 2 is fixed on a man's waist in the sequence shown in FIG. 22 a, b, c, d. In FIG. 22 c it is obvious that element 6 is half-folded inside the layer of rectangular cloth 2 formed by turning, the cloth is adjacent the waist of object 22 (man's body), in such a way rectangular cloth 2 (i.e. towel) is fixed on the waist preventing its sliding down. Γ-type fastening element 9 (FIG. 32) can also be used; it is fixed on a man's waist in the sequence shown in FIGS. 32 a, b, c, d.

When using the claimed method and device as a headband, rectangular cloth 2 with two partially fixed rectangular fastening elements 7 (located along the longer sides of the cloth and in the center of its shorter sides) should be chosen. In FIG. 23 a, b, c, d, e the fastening of rectangular cloth 2 on the head is shown.

When using the claimed method and device for cloth 1 as a mask, rectangular cloth 2 with four partially fixed rectangular fastening elements 7 (located along the longer sides of rectangular cloth 2 and on the edges of its shorter sides) should be used. In FIG. 24 a, b, c a mask fastening on the head is shown.

When using the claimed method and device for cloth 1 in the form of a screen with fastening on a frame, one should choose rectangular cloth 2 with four partially fixed fastening elements 7 located along the right and the left edge of the longer sides of rectangular cloth 2, at the top and at the bottom respectively, and two rectangular fastening elements 7 partially fixed in the center of the right and left longer sides of rectangular cloth 2. In FIG. 25 a, b, c the fastening of rectangular cloth 2 on a screen frame is shown.

When using the claimed method and device for a sofa cover, one should choose square cloth 3 with four partially fixed rectangular fastening elements 7. In FIG. 26 a, b a cover fastening on a sofa is shown.

When using the claimed method and device for a tablecloth, for its fastening on a table one should use round cloth 5 with four semicircular fastening elements 11 partially fixed in it and located symmetrically along its circle. In FIGS. 27 a, b the fastening of round cloth 5 in the form of a tablecloth is shown.

When using the fastening method for cloth 1 in the form of a tablecloth one should use, for example, round cloth 1 with 4 rigidly fixed rectangular fastening elements 6 located along round cloth 1 circle and symmetrically along its diameters, then round cloth 1 is fixed on a round table top in the sequence shown in FIGS. 28 a, b. In FIG. 28 b it is obvious that the fastening element 6 is folded towards the side of a round table top, then the same action is performed for the rest of fastening elements 6 in any sequence, the described method ensures prompt fastening of a tablecloth on a round table top.

When using the claimed method and device for a lace pillow cover, one should use round cloth 5 with four rectangular fastening elements 7 partially fixed in it and located evenly along its radii. In FIG. 29 a, b the fastening of a cover in the form of round cloth 5 on a pouffe is shown.

When using the claimed method and device for fastening of cloth 1 in the form of a towel one should use, for example, rectangular cloth 2 with two wire fastening elements 8 (FIG. 36) rigidly fixed in the cloth along its shorter sides, the rectangular cloth is then fixed on a towel rail in the sequence shown in FIG. 36 a, b, c. In FIG. 36 b it is obvious that wire fastening element 8 is half-folded round object 22 (a towel rail), then the same actions are performed for the second wire fastening element 8 (FIG. 36 c), these actions ensure rigid fastening of a towel on object 22 (a towel rail).

When using the method of fastening and device for cloth 1 in the form of a towel one should use, for example, rectangular cloth 2 with two wire fastening elements 8 (FIG. 37) rigidly fixed in the cloth along its shorter sides, then rectangular cloth 1 is fixed on object 22 (a man's waist) in the sequence shown in FIGS. 37 a, b, c, d, e. In FIG. 37 b it is obvious that rectangular cloth 2 is positioned behind in such a way that the center of one of the longer sides should be near the waist and wire fastening elements 8 should be on the right and on the left side respectively. Then, the left edge of rectangular cloth 2 is turned round the waist on the left side in the direction from the rear and to the front (FIG. 37 c), then the same action is performed behind on the right side in such a way that the right edge of rectangular cloth 2 slightly covers its left edge (FIG. 37 d). Then one takes the left corner of rectangular cloth 2 with wire fastening element 8 fixed in it and folds it by a half and with little angle towards the right part of rectangular cloth 2 with wire fastening element 8 fixed in it, by these actions rectangular cloth (FIG. 37 e) is fixed and rigid fastening of a towel on a man's waist is ensured.

When using the method and device for fastening of cloth 1 in the form of a curtain, one can use, for example, rectangular cloth 2 with seven rectangular fastening elements partially fixed in it and located crosswise one of the longer sides and at even distance from each other, then cloth 1 is fixed on a ledge in the sequence shown in FIGS. 38 a, b, c. In FIG. 38 b it is obvious that rectangular fastening elements 7 a folded by more than a half round the ledge (FIG. 38 b). Then the same actions are performed with rectangular fastening elements 7 one by one (FIG. 38 c), this ensures rigid fastening of a curtain on a ledge.

When using the method and device fir fastening of cloth 1 in the form of an apron one should use, for example, cloth 2 in the form of a pentagon with two equal sides and two rectangular fastening elements 6 partially fixed along the upper edge of the unequal side and two partially fixed rectangular fastening elements 6 parallel the first ones in the opposite corners (FIG. 39), then the cloth is fixed on a man's waist in the sequence shown in FIGS. 39 a, b, c, d, e, f. The cloth should be positioned in the front in such a way that the center of the upper edge of the unequal side coincides with the center of the waist (FIG. 39 b). The left and right corners of pentagonal cloth 1 are put together behind in such a way that the right edge, partially fixed along the edge of the unequal side, covers the left one, and right fastening element 6 fixed in the corner covers the left one (FIG. 39 c). The left fastening element 6 is folded by 180 degrees (FIG. 39 d), then the right one is also folded by 180 degrees to cove the left element (FIG. 39 c), then the same actions are performed with two fastening elements 6 fixed in the opposite corners (FIG. 39 f), these actions ensure rigid fastening of an apron on a man's waist.

When using the method and device fir fastening of cloth 1 in the form of breeches one should use, for example, pentagonal cloth 1 with two equal sides and two rectangular fastening elements 6 partially fixed along the upper edge of the unequal side and two partially fixed rectangular fastening elements 6 parallel the first ones in the opposite corners (FIG. 40), then the cloth is fixed on a man's waist and under the knees in the sequence shown in FIGS. 40 a, b, c, d, e, f, g. Cloth 1 is positioned behind in such a way that the center of the upper edge of the unequal side coincides the center of the waist (FIG. 40 b). The left and right edges of pentagonal cloth 1 are put together in the front in such a way that the right edge partially fixed along the upper edge of unequal side covers the left one (FIG. 40 b). Then, one takes the bottom corner of cloth 1, which has no fastening elements 2, and pass it between the legs from behind to the front (FIG. 40 c) in such a way that it goes slightly upper than the two overlapping upper fastening elements 6, after this the corner should be folded inside, under fastening elements 6 (FIG. 40 d). Then one takes left fastening element 6 fixed along the upper edge of the unequal side and folds it by 180 degrees, then one folds the right one by 180 degrees to overlap the first one (FIG. 40 e). One takes fastening element 6 partially fixed in the right corner of cloth 1 and spirally folds it round the right leg under the knee, and left fastening element 6 partially fixed in the right corner of cloth 6 is spirally folded round the left leg under the knee (FIG. 40 f), these actions ensure rigid fastening of breeches on the waist and under the knees of a man.

When using the method and device for fastening of cloth 1 in the form of a floor rag, one should use, for example, rectangular cloth 1 with two rectangular fastening elements 6 partially fixed in it along the edges of the longer sides and two fastening elements 6 partially fixed in its crosswise the longer sides (FIG. 41), then cloth 1 is fixed on a mop in the sequence shown in FIGS. 41 a, b, c. In FIG. 41 b it is obvious that fastening element 2 is folded by more than a half on the upper part of a mop base, then the same actions are performed with the rest of fastening elements 6 in any sequence (FIG. 41 c), this ensures rigid fastening of a floor rag on a mop.

### INDUSTRIAL APPLICABILITY

The described technical solution ensures the following: significant expansion of the spheres of usage, unification of the fixing cloth for different purposes, facilitation of production of the fixing cloth, a decrease in time, intellectual, and physical inputs for preparation of the product ready for usage. The claimed method and device make it possible to produce and use a wide range of different products:
furniture covers;
car seat covers;
train and plane seats covers;
bath and beach accessories;
hats;
face bandages;
lace pillow covers;
bedspreads;
covers and centerpiece for headrests and pillows;
tablecloths;
baby's bibs;
belts;
headbands;
neck accessories;
bracelets;
floor rags;
capes for barber shop;
special wear;
medical accessories; etc.

For cloth 1, material is chosen in accordance with its function and purpose, for example: sateen, viscose, terry cotton cloth, upholstery cloth, thick gauze etc. also, one can use plastic impregnated cloth provided that the cloth 1 is used outdoors and on a site not protected from atmospheric effects.

For covers 13 one can use different elements of sewing accessories (ribbons, ornamental borders, covers), textile remains matching the main cloth (for aesthetic purposes), an also cuttings of denim To form a pocket one can hem a part of the main cloth from the side part by folding it inside, at that a pocket is formed for fastening element 6. This ensures a decrease in production costs.

The claimed method and device have several advantages over the closest analogues:
effectiveness of cloth consumption;
easiness of the production technology;
easiness of the cut;
usage of simple manufacturing capacity;
accessibility of materials for fastening elements production;
easiness of usage;
multiple usage;
a lot of functions i.e. the device can be used for different objects, on which a cloth should be fixed; this was proved by the stated examples.

Investigations of patent sources prove the novelty of the method and device.

The device being claimed can be manufactured in a factory producing clothes, tailoring shop, where ordinary sewing equipment of any type and minimum functions and standard materials and simple technologies are used.

Therefore, the method and device being claimed have industrial utility.

The claimed set of factors ensures the new features of the claimed device, which provide obtaining of a technical result i.e. an expansion of functions of the method and device being claimed, a reduction of time before usage (putting on and fastening), facilitation of technology, and also a decrease in production costs taking into consideration the possibility of usage by people having different clothes sizes or objects of different sizes; the possibility can not be provided by the closest analogues, which can be fixed only on certain surfaces, but not on any surfaces. Usage of different elements in the closest analogues: because of a textile ribbon sewn along the whole length of the product and buttonholes and fastening elements located on the right and left sides the product cannot be used as a multifunctional device. This means that its usage on any object leads to its full folding around an object, and only after that the product can be fixed.

The invention by device consists in that the claimed device for cloth fastening includes, at least, one fastening element, which is made with a possibility of multiple folding and unfolding and is fixed on the cloth with prevention of its free moving along it, and at that fastening element made of light and soft metal is rigidly fixed in the folded position. In one solution fastening elements are partially fixed on the cloth. Fastening elements can be of different form depending on the form of the cloth. Brass is used as material for fastening elements production. The fastening element is enclosed in a plastic casing. In other solution a fastening element is made of multi-cored copper wire in a plastic casing. Fastening elements are fixed to the cloth in different places. In one of the solutions the fastening elements are fixed in the cloth turn-up of the finished product. In other solution the fastening elements are fixed to the cloth via additional covers, for example, made of cloth.

The claimed set of factors ensures new features of the claimed solution, which help to solve the stated problem.

Items List

Cloth 1

Rectangular cloth 2

Square cloth 3

Triangular cloth 4

Round cloth 5

Fastening element 6

Rectangular fastening element 7

Wire fastening element 8

Γ-type fastening element 9

Triangular fastening element 10

Semicircular fastening element 11

Casing 12

Cover 13

One-sided rectangular cover 14

Two-layer rectangular cover 15

Γ-type cover 16

Triangular cover 17

Semicircular cover

Turn-up of the cloth edge 19

Turn-up of a separate cut in the cloth body 20

Decorative piping 21

Object 22, on which cloth 1 of any form can be fixed.

What is claimed is:

1. A method of fastening a cloth comprising
fastening the cloth with fastening elements on a surface of the cloth;
wherein the fastening elements are fixed within the cloth to prevent free motion of the fastening elements along the cloth;
wherein the fastening elements are capable of being folded and unfolded multiple times; and
wherein the fastening elements are capable of being rigidly fixed in a folded shape.

2. The method of claim 1 further comprising folding one of the fastening elements 90° across its length at a straight edge of the surface and then folding the one of the fastening elements additional 90°.

3. The method of claim 1 further comprising folding one of the fastening elements across its length at a rounded edge of the surface to go around the edge, wherein an edge of the one of the fastening elements after going around the edge of the surface contacts an inner side of the surface.

4. The method of claim 1 further comprising folding one of the fastening elements across its length at a contoured edge of the surface to go around the edge, wherein an edge of the one of the fastening elements after going around the contoured edge of the surface contacts an inner side of the surface.

5. The method of claim 1 further comprising folding one of the fastening elements across its length into a spiral around the surface.

6. A device for fastening a cloth comprising
at least one fastening element;
wherein the at least one fastening element is capable of being folded and unfolded multiple times;
wherein the at least one fastening element is fixed within the cloth to prevent free motion of the at least one fastening element along the cloth;
wherein the at least one fastening element is made of a light soft metal; and
wherein the at least one fastening element is capable of being rigidly fixed in a folded shape.

7. The device of claim 6, wherein the at least one fastening element is partially fixed within the cloth.

8. The device of claim 6, wherein a shape at least one fastening element depends on a shape of the cloth.

9. The device of claim 6, wherein the metal is brass.

10. The device of claim 6, wherein the at least one fastening element is in a plastic casing.

11. The device of claim 6, wherein the at least one fastening element is made of a multi-cored copper wire in a plastic casing.

12. The device of claim 6, wherein the at least one fastening element is capable of being fixed at multiple locations on the cloth.

13. The device of claim 6, wherein the at least one fastening element is fixed in a turn-up of the cloth.

14. The device of claim 6, wherein the at least one fastening element is fixed in the cloth using an additional patch.
